(19) United States
(12) Patent Application Publication
(10) Pub. No.: US 2023/0178045 A1
(43) Pub. Date: Jun. 8, 2023

(54) DISPLAY APPARATUS AND CONTROL METHOD THEREOF

(71) Applicant: SAMSUNG ELECTRONICS CO., LTD., Suwon-si (KR)

(72) Inventors: Sungjin LIM, Suwon-si (KR); Sungsoo KIM, Suwon-si (KR)

(21) Appl. No.: 18/104,519

(22) Filed: Feb. 1, 2023

Related U.S. Application Data
(63) Continuation of application No. PCT/KR2021/010673, filed on Aug. 11, 2021.

(30) Foreign Application Priority Data
Sep. 15, 2020 (KR) 10-2020-0118601

(51) Int. Cl. G09G 3/36

(52) U.S. Cl. CPC G09G 3/3648; G09G 2340/0435; G09G 2310/0213; G09G 2310/08; G09G 2354/00; G09G 2320/0606; G09G 2320/0613; G09G 2320/08; G09G 2310/021

(57) ABSTRACT

A display apparatus may comprise: a panel driving unit comprising driving circuitry, a display panel, and a processor configured to control the panel driving unit, wherein the processor is configured to: control the panel driving unit to output gate signals to multiple gate lines sequentially one by one to process image data at a first driving frequency in a first mode, and control the panel driving unit to output gate signals to the multiple gate lines sequentially at least two gate lines at a time to process image data at a second driving frequency higher than the first driving frequency in a second mode.

### CROSS-REFERENCE TO RELATED APPLICATIONS

This application is a continuation of International Patent Application No. PCT/KR2021/010673 designating the United States, filed on Aug. 11, 2021, in the Korean Intellectual Property Receiving Office and claiming priority to Korean Patent application No. 10-2020-0118601, filed on Sep. 15, 2020, in the Korean Intellectual Property Office, the disclosures of which are incorporated by reference herein in their entireties.

### BACKGROUND

### Field

The disclosure relates to a display apparatus and a control method thereof, and for example, to a display apparatus which may display an image through restraint drive, and a control method thereof.

### Description of Related Art

In recent years, an image having a high frame rate (HFR) has been provided in accordance with the development of electronic technology. Such an image may be reproduced without interruption by a display apparatus capable of processing image data at a frequency such as 120 Hz or 240 Hz, that is, capable of being driven at a high speed.

However, a conventional display apparatus may only process the image data based on a predetermined driving frequency or a frequency lower than the predetermined driving frequency. Accordingly, the display apparatus may not operate at an driving frequency of 120 Hz or higher when its driving frequency is set to 60 Hz.

This problem may cause a disconnection phenomenon during reproduction of a game image, a sports image, or the like having the high frame rate (or a high frames per second), and a user cannot enjoy the images smoothly.

### SUMMARY

Embodiments of the disclosure provide a display apparatus which may smoothly reproduce an image having a high frame rate without interruption through restraint drive, and a control method thereof.

According to an example embodiment of the present disclosure, a display apparatus includes: a panel driving unit comprising panel driving circuitry; a display panel including a plurality of pixels connected to a plurality of gate lines and a plurality of data lines through a plurality of switching elements, each comprising a switching circuit; and a processor configured to: control the panel driving unit to output a gate signal through the plurality of gate lines, and control the panel driving unit to apply a data voltage to the plurality of pixels connected to the plurality of switching elements to which the gate signal is output, through the plurality of data lines, wherein the processor is configure to control the panel driving unit to sequentially output the gate signals by every one gate line to the plurality of gate lines in a first mode to process image data at a first driving frequency, and control the panel driving unit to sequentially output the gate signals by at least every two gate lines to the plurality of gate lines in a second mode to process the image data at a second driving frequency g than the first driving frequency.

While operating in the first mode, the processor may be configured to: control the panel driving unit to apply the data voltage to the plurality of pixels based on a timing at which the gate signals are sequentially output by every one gate line to the plurality of switching elements, and while operating in the second mode, the processor may control the panel driving unit to apply the data voltage to the plurality of pixels based on a timing at which the gate signals are sequentially output by at least every two gate lines to the plurality of switching elements.

The gate line may include a first gate line and a second gate line, and while operating in the first mode, the processor may be configured to control a gate driving unit to output a first gate signal to the plurality of switching elements connected to the first gate line through the first gate line at a first timing, and control the panel driving unit to output a second gate signal to the plurality of switching elements connected to the second gate line through the second gate line at a second timing.

While operating in the second mode, the processor may be configured to control the panel driving unit to output the gate signal to the plurality of switching elements connected to the first gate line and the plurality of switching elements connected to the second gate line through the first and second gate lines at the same timing.

The apparatus may further include an input unit comprising input circuitry, wherein the processor operates in the first mode to process the image data at the first driving frequency based on receiving a command for setting a mode of the display apparatus to the first mode through the input unit, and operates in the second mode to process the image data at the second driving frequency based on receiving a command for setting the mode of the display apparatus to the second mode through the input unit.

The processor may be configured to perform an automatic content recognition (ACR) function to determine a type of the image data when receiving the image data from the outside, operate in the first mode to process the image data at the first driving frequency based on determining the type of the image data as a first type, and operate in the second mode to process the image data at the second driving frequency based on determining the type of the image data as a second type.

The processor may be configured to determine frames per second (fps) of the image data when receiving the image data from the outside, operate in the first mode to process the image data at the first driving frequency based on the frames per second of the image data having a first value, and operate in the second mode to process the image data at the second driving frequency based on the frames per second of the image data having a second value.

The processor may be configured to convert the image data into second image data having the frames per second of the second value based on receiving first image data having the frames per second of the first value from the outside, and process the second image data at the second driving frequency.

According to an example embodiment of the present disclosure, a method of controlling a display apparatus includes: outputting a gate signal through a plurality of gate lines; and applying a data voltage to a plurality of pixels connected to a plurality of switching elements to which the gate signal is output, through a plurality of data lines, wherein the outputting the gate signal comprises: in a first mode, sequentially outputting the gate signals by every one gate line to the plurality of gate lines to process image data at a first driving frequency, and in a second mode, sequentially outputting the gate signals by at least every two gate lines to the plurality of gate lines to process the image data at a second driving frequency higher than the first driving frequency.

In the applying of the data voltage, while operating in the first mode, the data voltage may be applied to the plurality of pixels based on a timing at which the gate signals are sequentially output by every one gate line to the plurality of switching elements, and during the second mode, the data voltage may be applied to the plurality of pixels based on a timing at which the gate signals are sequentially output by at least every two gate lines to the plurality of switching elements.

The gate line may include a first gate line and a second gate line, and in the outputting of the gate signal, while operating in the first mode, a first gate signal may be output to the plurality of switching elements connected to the first gate line through the first gate line at a first timing, and a second gate signal may be output to the plurality of switching elements connected to the second gate line through the second gate line at a second timing.

In the outputting of the gate signal, while operating in the second mode, the gate signal may be output to the plurality of switching elements connected to the first gate line and the plurality of switching elements connected to the second gate line through the first and second gate lines at the same timing.

The method may further include: receiving a command for setting a mode of the display apparatus; and operating in the first mode to process the image data at the first driving frequency based on a command for setting the mode of the display apparatus to the first mode being received, and operating in the second mode to process the image data at the second driving frequency based on a command for setting the mode of the display apparatus to the second mode being received.

The method may further include: performing an automatic content recognition (ACR) function to determine a type of the image data based on the image data being received from the outside; and operating in the first mode to process the image data at the first driving frequency based on the type of the image data being determined as a first type, and operating in the second mode to process the image data at the second driving frequency based on the type of the image data being determined as a second type.

The method may further include: determining frames per second (fps) of the image data based on the image data being received from the outside; and operating in the first mode to process the image data at the first driving frequency based on the frames per second of the image data having a first value, and operating in the second mode to process the image data at the second driving frequency based on the frames per second of the image data having a second value.

The method may further include converting the image data into second image data having the frames per second of the second value based on first image data having the frames per second of the first value being received from the outside, and processing the second image data at the second driving frequency.

According to the various example embodiments of the present disclosure as described above, it is possible to provide the display apparatus which may smoothly reproduce the image having a high frame rate without any interruption, and the control method thereof.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of a display apparatus according to various embodiments;

FIG. 2 is a diagram illustrating driving of the display apparatus according to various embodiments;

FIG. 3 is a timing diagram illustrating an example in which gate signals are sequentially output by at least every two gate lines according to various embodiments;

FIG. 4 is a timing diagram illustrating an example in which the gate signals are sequentially output by every one gate line according to various embodiments;

FIG. 5 is a diagram illustrating an example configuration of the display apparatus according to various embodiments;

FIG. 6 is a block diagram illustrating an example configuration of the display apparatus according to various embodiments;

FIG. 7 is a block diagram illustrating an example configuration of the display apparatus according various embodiments; and

FIG. 8 is a flowchart illustrating an example method of controlling a display apparatus according to various embodiments.

### DETAILED DESCRIPTION

Terms used in this disclosure or the claims are selected from general terms in consideration of its function in the present disclosure. However, the terms may be changed based on intentions of those skilled in the art to which the present disclosure pertains, legal or technical interpretations, and emergences of new technology. In addition, various terms may be arbitrarily selected. These terms may be interpreted to have the meaning defined in this disclosure, and if there is no specific definition of the term, it may be interpreted based on a general content of this disclosure and common technical knowledge in the art.

Further, in describing the present disclosure, a detailed description of a case where the detailed description for the known functions or configurations related to the present disclosure may unnecessarily obscure the gist of the present disclosure may be omitted.

Furthermore, embodiments of the present disclosure are described in greater detail with reference to the accompanying drawings and the contents shown in the accompanying drawings, and the present disclosure is not limited or restricted to the various example embodiments.

Hereinafter, the present disclosure is described in greater detail with reference to the accompanying drawings.

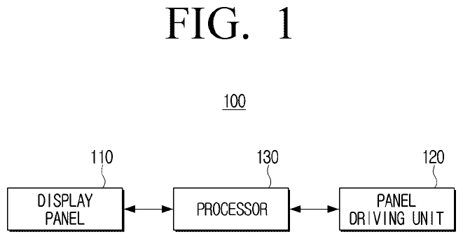

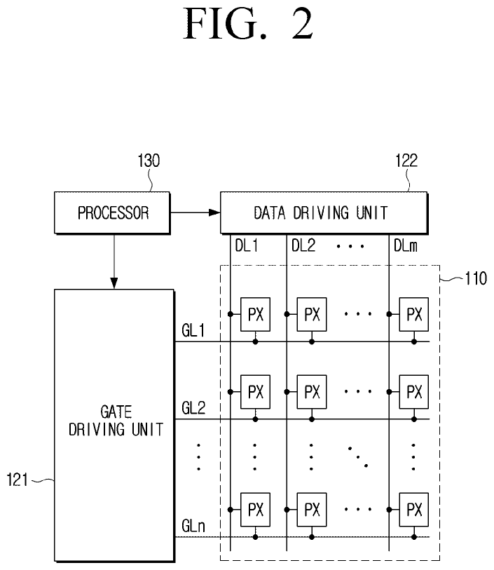

FIG. 1 is a block diagram illustrating an example configuration of a display apparatus according to various embodiments; and FIG. 2 is a diagram illustrating example driving of the display apparatus according to various embodiments.

A display apparatus 100 according to an embodiment of the present disclosure may be any of various electronic devices having a display such as, for example, and without limitation, a television (TV), a monitor, a laptop computer, a tablet personal computer (PC), a personal digital assistant (PDA), a smartphone, and the like.

Referring to FIG. 1, the display apparatus 100 according to an embodiment of the present disclosure may include a display panel 110, a panel driving unit (e.g., including panel driving circuitry) 120, and a processor (e.g., including processing circuitry) 130.

The display panel 110 may display various images. For example, the display panel 110 may display a pre-stored image as well as an image received from an external device. Here, the external device may be any of various electronic devices which may transmit an image to the display apparatus 100, such as a server, a computer, a laptop computer, and a smartphone.

The image may include at least one of a still image and a video, and the display panel 110 may display various images such as broadcast content and multi-media content. In addition, the display panel 110 may display various user interfaces (UIs) and icons.

For example, the display panel 110 may display an image having a high frame rate (HFR) by the panel driving unit 120 operating at an driving frequency of 120 Hz or 240 Hz, for example. The HFR image may be an image having, for example, 120 frames or more per second, and may be, for example, a game image or a sports image, and is not necessarily limited thereto.

Such a display panel 110 may be implemented as a liquid crystal display panel (LCD) type display. However, in various embodiments, the display panel 110 may be implemented as any of various types of displays such as, for example, and without limitation, a light emitting diode (LED), an organic light emitting diode (OLED), a liquid crystal on silicon (LCoS), and a digital light processing (DLP). In addition, the display panel 110 may also include a driving circuit, a backlight unit, or the like, which may be implemented by an amorphous silicon (a-si) TFT, a low temperature poly silicon (LIPS) TFT, or an organic TFT (OTFT).

In addition, the display panel 110 may be implemented as a touch screen in combination with a touch sensor.

In addition, the display panel 110 may include a plurality of pixels connected to a plurality of gate lines and a plurality of data lines through a plurality of switching elements.

The panel driving unit 120 may display the image through the plurality of pixels included in the display panel 110.

Referring to FIG. 2, the panel driving unit 120 may include a gate driving unit (e.g., including gate driving circuitry) 121 connected to the switching element (e.g., including circuitry such as, for example, and without limitation, a thin-film transistor) included in each pixel PX through a plurality of gate lines GL1, GL2, . . . , and GLn, and a data driving unit (e.g., including data driving circuitry) 122 connected to the switching element included in each pixel PX through a plurality of data lines DL1, DL2, . . . , and DLn.

The pixel may include the switching element, a pixel electrode connected to the switching element, and a common electrode.

In addition, the switching element may be, for example, the thin film transistor (TFT).

The switching element may be turned on by a gate signal output through the gate line. In this case, as described below, data voltage applied along the plurality of data lines by the data driving unit 122 may be applied to the pixel electrode (e.g., capacitor) included in each pixel. To this end, a first terminal of the switching element may be connected to the gate line, and a second terminal thereof may be connected to the data line.

The switching element may be turned off when a gate low signal is output through the gate line, and in this case, the data voltage charged in the pixel electrode may be maintained for a predetermined time.

The gate driving unit 121 may receive a gate driving control signal from the processor 130. The gate driving control signal may include a scan start signal including scan start information and a clock control signal for controlling an output timing of a gate signal.

In addition, the gate driving unit 121 may adjust the output timing of the gate signal based on the scan start signal. The gate signals may be, for example, pulse signals and sequentially output to the switching element included in each pixel PX through at least one gate line.

In this case, the switching element may be turned on by the gate signal output through the gate line, and the data line and the pixel electrode may be electrically connected with each other.

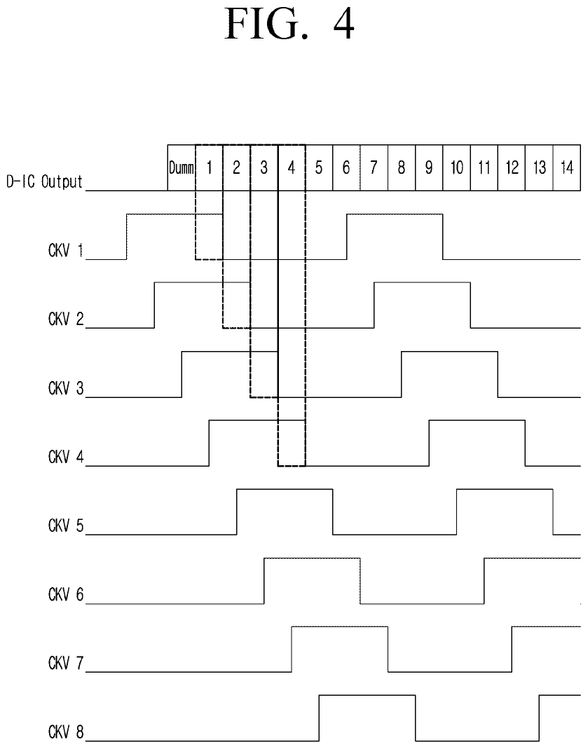

According to an embodiment of the present disclosure, the gate driving unit 121 may sequentially output the gate signals by every one gate line while the display apparatus 100 operates in a first mode. This configuration is described in greater detail below with reference to FIG. 4.

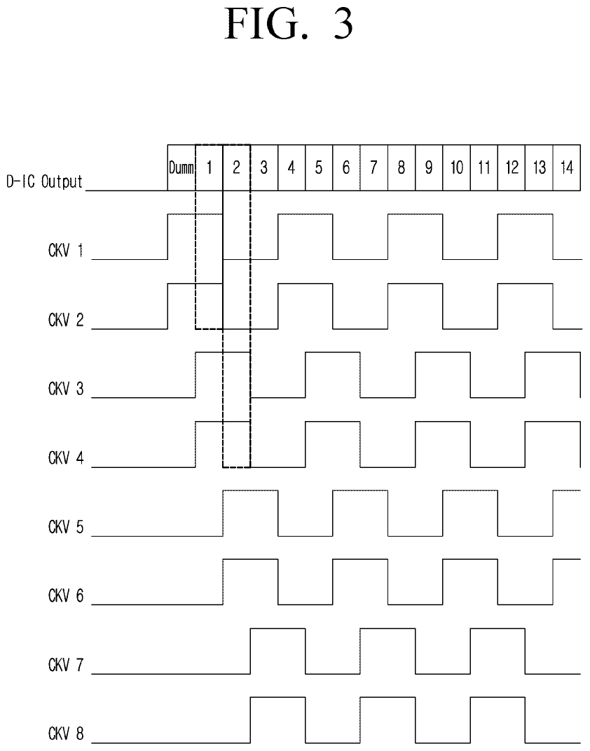

In addition, the gate driving unit 121 may sequentially output the gate signals by at least every two gate lines while the display apparatus 100 operates in a second mode. This configuration is described in greater detail below with reference to FIG. 3.

The data driving unit 122 may receive a data driving control signal and a digital image signal from the processor 130. The digital image signal may include information on a plurality of grayscale values corresponding to the plurality of pixels positioned in at least one row (or horizontal line) of the plurality of pixels.

In addition, the data driving unit 122 may obtain the data voltage (or grayscale voltage) corresponding to the digital image signal based on the information on the plurality of grayscale values included in the digital image signal. In addition, the data driving unit 122 may apply the data voltage to the plurality of pixel electrodes included in the plurality of pixels through the plurality of data lines.

The pixel including the pixel electrode to which the data voltage is applied may be a pixel including the switching element turned on based on the gate signal.

The data voltage applied through the plurality of data lines may be applied to the pixel electrode of the pixel including the corresponding switching element through the turned-on switching element. To this end, a third terminal of the switching element may be connected to the pixel electrode included in each pixel.

Liquid crystal molecules included in each pixel may be arranged differently based on a difference between the data voltage applied to the pixel electrode and a common voltage applied to the common electrode. Accordingly, light transmittance of each pixel may be changed, and the display panel 110 may implement a grayscale based on the changed light transmittance.

The processor 130 may include various processing circuitry and control overall operations of the display apparatus 100. The processor 130 may drive an operating system or an application program to control hardware or software components connected to the processor 130, and perform various kinds of data processing and calculation. In addition, the processor 130 may load and process commands or data received from at least one of other components in the volatile memory, and store various data in the non-volatile memory. The processor 130 may be, for example, a timing controller, and is not necessarily limited thereto.

The processor 130 may control the panel driving unit 120 (e.g., gate driving unit 121) to output the gate signal through the plurality of gate lines, and control the panel driving unit 120 (e.g., the data driving unit 122) to apply the data voltage to the plurality of pixels connected to the plurality of switching elements to which the gate signal is output, through the plurality of data lines.

For example, the processor 130 may process the digital image signal (or image data) received from the outside to generate the digital image signal corresponding to each pixel of the display panel 110. In addition, the processor 130 may generate the gate driving control signal and the data driving control signal based on a horizontal synchronization signal, a vertical synchronization signal, and a clock signal, received from the outside, transmit the gate driving control signal to the gate driving unit 121, and transmit the digital image signal and the data driving control signal to the data driving unit 122.

The gate driving control signal may include the scan start signal including the scan start information and the clock control signal for controlling the output timing of the gate signal. The gate driving unit 121 may sequentially output the gate signals by at least every one gate line at an appropriate timing based on the scan start signal and the clock control signal.

In this case, the plurality of switching elements connected to the gate line outputting the gate signal may be turned on.

The data driving control signal may include, for example, a horizontal synchronization start signal including information on data transmission start and a control signal controlling application of the data voltages through the plurality of data lines.

The data driving unit 122 may apply the data voltages to the plurality of pixels through the plurality of data lines at an appropriate timing based on the horizontal synchronization start signal and the control signal. Here, the pixel to which the data voltage is applied may be a pixel connected to the switching element turned on as a gate signal is output.

The processor 130 may process the image data received from the outside at a high-speed driving frequency.

For example, the processor 130 may process the image data at a second frequency higher than a first frequency predetermined by the display apparatus 100. Here, the first frequency may be 60 Hz and the second frequency may be 120 Hz. However, this configuration is an example, and the first frequency and the second frequency may be changed according to an example, such as the first frequency being 120 Hz and the second frequency being 240 Hz.

To this end, the processor 130 may control the panel driving unit 120 to sequentially output the gate signals by at least every two gate lines. Here, the panel driving unit 120 may be the gate driving unit 121 described above.

For example, the processor 130 may control the gate driving unit 121 to sequentially output the gate signals by every two gate lines.

For example, the processor 130 may transmit the scan start signal including the scan start information and the clock control signal for outputting the gate signals by two gate lines at a time to the gate driving unit 121, the gate driving unit 121 may then adjust the output timing of the gate signals by every two gate lines based on the scan start signal and the clock control signal, and sequentially output the gate signals by two gate lines at a time.

For example, referring to FIG. 3, the gate driving unit 121 according to an embodiment of the present disclosure may be connected to the first to eighth gate lines, and the processor 130 may control the gate driving unit 121 to output the gate signals by every two gate lines.

In this case, the gate driving unit 121 may output gate signals CKV1 and CKV2 through first and second gate lines to the plurality of switching elements connected to the first gate line and the plurality of switches connected to the second gate line at a first timing.

The plurality of switching elements connected to the first and second gate lines may be turned on by the gate signal output through the gate lines. In addition, the pixel electrode included in the pixel may be electrically connected with the data line connected to the data driving unit 122 as the switching element is turned on.

Accordingly, a first data voltage output by the data driving unit 122 may be applied to the pixel electrode connected to the turned-on switching element through the plurality of data lines.

The gate driving unit 121 may then output gate signals CKV3 and CKV4 through third and fourth gate lines to the plurality of switching elements connected to the third gate line and the plurality of switching elements connected to the fourth gate line at a second timing.

The plurality of switching elements connected to the third and fourth gate lines may be turned on by the gate signal output through the gate lines. In addition, the pixel electrode included in the pixel may be electrically connected with the data line connected to the data driving unit 122 as the switching element is turned on.

Accordingly, a second data voltage output by the data driving unit 122 may be applied to the pixel electrode connected to the turned-on switching element through the plurality of data lines.

Similarly, the gate driving unit 121 may output gate signals CKV5 and CKV6 to the plurality of switching elements connected to the fifth gate line and the plurality of switching elements connected to the sixth gate line, through fifth and sixth gate lines at a third timing, and a third data voltage output by the data driving unit 122 may be applied to the pixel electrode connected to the turned-on switching element through the plurality of data lines.

In addition, the gate driving unit 121 may output gate signals CKV7 and CKV8 through seventh and eighth gate lines to the plurality of switching elements connected to the seventh gate line and the plurality of switching elements connected to the eighth gate line at a fourth timing, and a fourth data voltage output by the data driving unit 122 may be applied to the pixel electrode connected to the turned-on switching element through the plurality of data lines.

The liquid crystal molecules included in each pixel may be arranged differently based on the difference between the data voltage applied to the pixel electrode and the common voltage applied to the common electrode. Accordingly, the light transmittance of each pixel may be changed based on the application of the above-described first to fourth data voltages, and the display panel 110 may implement the grayscale based on the changed light transmittance.

As such, the present disclosure may enable high-speed driving by outputting the gate signal by at least every two gate lines when compared to a conventional display apparatus that outputs the gate signal by every one gate line, and thus reproduce the HFR image without any interruption. For example, the conventional display apparatus operating at the driving frequency of 60 Hz may not smoothly reproduce the image data requiring the driving frequency of 120 Hz. However, the present disclosure may operate at the driving frequency of 120 Hz or more by outputting the gate signals by at least every two gate lines even when a basic driving frequency of the display apparatus is set to 60 Hz, and thus reproduce the HFR image requiring the driving frequency of 120 Hz without any interruption.

Meanwhile, the description above describes an example in which the gate signals are sequentially output by every two gate lines. However, the present disclosure may sequentially output the gate signals by every three or more gate lines based on a frame rate of the image data and frames per second of the image data.

In addition, the output timing of the gate signal and the output timing of the data voltage, shown in FIG. 3, are examples, and the timing at which the gate driving unit 121 outputs the gate signal and the timing at which the data driving unit 122 outputs the data voltage may be different from those shown in FIG. 3. For example, the timing at which the gate driving unit 121 outputs the gate signal and the timing at which the data driving unit 122 outputs the data voltage may be variously set or changed according to examples.

The processor 130 may control the gate driving unit 121 to sequentially output the gate signals by every one gate line or by every two or more gate lines based on a mode of the display apparatus.

For example, the processor 130 may control the panel driving unit 120 (e.g., gate driving unit 121) to sequentially output the gate signals by every one gate line to process the image data at a first driving frequency in the first mode, and control the panel driving unit 120 (e.g., gate driving unit 121) to sequentially output the gate signals by at least every two gate lines to process the image data at a second driving frequency higher than the first driving frequency in the second mode.

In this case, while operating in the first mode, the processor 130 may control the panel driving unit 120 (e.g., data driving unit 122) to apply the data voltage to the plurality of pixels based on the timing at which the gate signals are sequentially output by every one gate line to the plurality of switching elements connected to the gate lines, and while operating in the second mode, the processor 130 may control the panel driving unit 120 (e.g., data driving unit 122) to apply the data voltage to the plurality of pixels based on the timing at which the gate signals are sequentially output by at least every two gate lines to the plurality of switching elements connected the plurality of gate lines.

An operation of the display apparatus 100 in the second mode is as that described above with reference to FIG. 3.

Hereinafter, the description describes an operation of the display apparatus 100 in the first mode with reference to FIG. 4.

The processor 130 may process the image data received from the outside at the basic driving frequency.

For example, the processor 130 may process the image data at a predetermined (e.g. specified) driving frequency by the display apparatus 100. The predetermined driving frequency may be, for example, 60 Hz, and is not necessarily limited thereto.

To this end, the processor 130 may control the panel driving unit 120 to sequentially output the gate signals by every one gate line. Here, the panel driving unit 120 may be the gate driving unit 121 described above.

For example, the processor 130 may transmit the scan start signal including the scan start information and the clock control signal for controlling the output timing of the gate signals by every one gate line to the gate driving unit 121, the gate driving unit 121 may then adjust the output timing of the gate signals by every one gate line based on the scan start signal and the clock control signal, and sequentially output the gate signals by every one gate line.

For example, referring to FIG. 4, the gate driving unit 121 according to an embodiment of the present disclosure may be connected to the first to eighth gate lines, and the processor 130 may control the gate driving unit 121 to output the gate signals by every one gate line.

In this case, the gate driving unit 121 may output the gate signal CKV1 to the plurality of switching elements connected to the first gate line through the first gate line at the first timing.

Accordingly, the plurality of switching elements connected to the first gate line may be turned on by the gate signal output through the first gate line. In addition, the pixel electrode included in the pixel may be electrically connected with the data line connected to the data driving unit 122 as the switching element is turned on.

Accordingly, the first data voltage output by the data driving unit 122 may be applied to the pixel electrode connected to the turned-on switching element through the plurality of data lines.

The gate driving unit 121 may then output the gate signal CKV2 to the plurality of switching elements connected to the second gate line through the second gate line at the second timing.

The plurality of switching elements connected to the second gate line may be turned on by the gate signal output through the gate line. In addition, the pixel electrode included in the pixel may be electrically connected with the data line connected to the data driving unit 122 as the switching element is turned on.

Accordingly, the second data voltage output by the data driving unit 122 may be applied to the pixel electrode connected to the turned-on switching element through the plurality of data lines.

Similarly, the gate driving unit 121 may output a gate signal CKVn to the plurality of switching elements connected to an nth gate line through the nth gate line at an nth timing, and an nth data voltage output by the data driving unit 122 may be applied to the pixel electrode connected to the turned-on switching element through the plurality of data lines.

The output timing of the gate signal and the output timing of the data voltage, shown in FIG. 4, are examples, and the timing at which the gate driving unit 121 outputs the gate signal and the timing at which the data driving unit 122 outputs the data voltage may be different from those shown in FIG. 4. For example, the timing at which the gate driving unit 121 outputs the gate signal and the timing at which the data driving unit 122 outputs the data voltage may be variously set or changed according to examples.

The light transmittance of each pixel may be changed based on the application of the above-described first to nth data voltages, and the display panel 110 may implement the grayscale based on the changed light transmittance.

The mode of the display apparatus 100 may be set based on a user command received through an input unit.

For example, the processor 130 may operate in the first mode to process the image data at the first driving frequency when receiving the user command for setting the mode of the display apparatus 100 to the first mode through the input unit, and operate in the second mode to process the image data at the second driving frequency higher than the first driving frequency when receiving the user command for setting the mode of the display apparatus 100 to the second mode through the input unit.

Processing at the first driving frequency may be to control the gate driving unit 121 to sequentially output the gate signals by every one gate line, and processing at the second driving frequency may be to control the gate driving unit 121 to sequentially output the gate signals by at least every two gate lines.

The input unit may include various input circuitry and may, for example, be a keyboard, mouse, or the like, as well as a touch screen. In addition, the input unit may be a communication unit (e.g., including communication circuitry), and the processor 130 may set the mode of the display apparatus 100 based on the user command when receiving a signal corresponding to the user command for setting or changing the mode of the display apparatus 100 from the external device through the communication unit. To this end, the processor 130 may display a user interface (UI) for setting the mode of the display apparatus on a screen of the display panel 110.

The processor 130 may automatically set or change the mode of the display apparatus 100.

For example, the processor 130 may perform an automatic content recognition (ACR) function to determine a type of the image data when receiving the image data from the outside. The automatic content recognition function may be a technique for extracting image information or sound information from content to recognize the image data. For example, the automatic content recognition function may be a technique for obtaining information on the title, type, or the like of the content by comparing the image information or sound information extracted from the content with pre-stored image information or sound information. To this end, the display apparatus 100 may store the image information or sound information of the plurality of contents. The processor 130 may extract the image information or sound information from the image data, transmit the extracted image information or sound information to the external device, and receive, from the external device, the information on the title, type, or the like of the content determined based on the image information or sound information of the image data.

In addition, the processor 130 may operate in the first mode to process the image data at the first driving frequency when determining the type of the image data as a first type through the automatic content recognition function, and operate in the second mode to process the image data at the second driving frequency when determining the type of the image data as a second type.

The first type may be the general broadcasting image or the like, and the second type may be the game image or the sports image, which are not necessarily limited thereto.

The processor 130 may set or change the mode of the display apparatus 100 based on the frames per second (fps) of the image data received from the outside.

To this end, the processor 130 may determine the frames per second (fps) of the image data when receiving the image data from the outside. For example, the processor 130 may determine the frames per second of the image data based on meta information of the image data.

In addition, the processor 130 may operate in the first mode to process the image data at the first driving frequency when the frames per second of the image data has a first value, and operate in the second mode to process the image data at the second driving frequency when the frames per second of the image data has a second value.

The first value may be 60 fps, and the second value may be 120 fps, which are not necessarily limited thereto. To this end, information on the first and second values may be stored in the display apparatus 100.

The processor 130 may change the frames per second (or frame rate) of the image data received from the outside, and process the image data through the high-speed driving.

For example, the processor 130 may convert the image data into second image data having the frames per second of the second value when receiving first image data having the frames per second of the first value from the outside, and process the second image data at the second driving frequency.

The first value may be 60 fps, and the second value may be 120 fps, which are not necessarily limited thereto.

To this end, the display apparatus 100 may further include a frame rate converter (FRC) for converting the frames per second of the image data or the frame rate of the image data.

In addition, when determining that the frames per second of the image data has the first value based on the meta information of the image data received from the outside, the processor 130 may convert the frames per second of the image data to have the second value through the FRC, and process the image data at the second driving frequency.

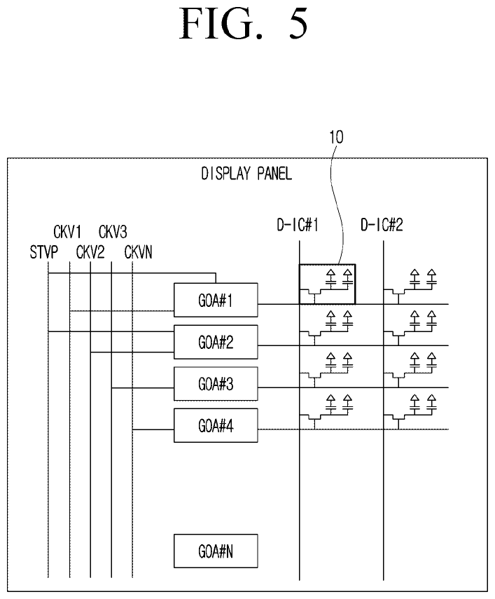

The gate driving unit 121 of FIG. 2 may be implemented as a gate driver on array (GOA) as shown, for example, in FIG. 5. The GOA may be a data driving circuit performing the functions of the gate driving unit 121 described above, which is manufactured on a substrate around the pixel, and the GOA may sequentially output the gate signals by every one gate line or by at least every two gate lines under control of the processor 130.

The gate signal may be output along the gate line by the GOA. In this case, the pixel electrode of a pixel 10 (or a left capacitor denoted by reference numeral 10) and the data line may be electrically connected with each other, and the data voltage may thus be applied to the pixel electrode through the data line. In addition, the liquid crystal molecules included in the pixel 10 may be arranged differently based on the difference between the pixel electrode and the common electrode (or a right capacitor denoted by reference numeral 10) of the pixel 10, light transmittance of the pixel 10 may be changed based on the arrangement of liquid crystal molecules, and the pixel 10 may implement the grayscale base on the changed light transmittance.

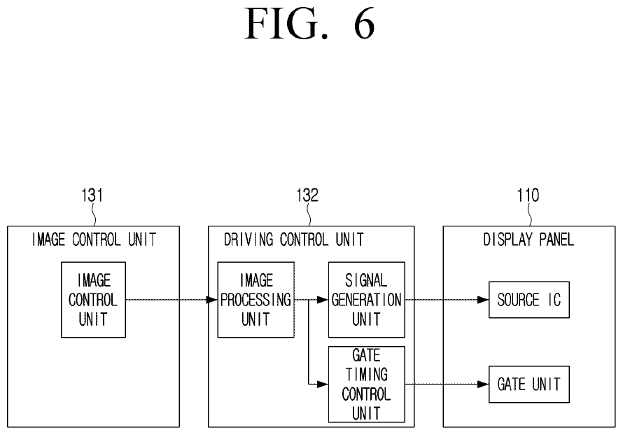

FIG. 6 is a block diagram illustrating an example configuration of the display apparatus according to various embodiments.

Although the display panel 110 and the panel driving unit 120 are separately shown in FIG. 2 for convenience of description, the panel driving unit 120 may be included in the display panel 110 as shown in FIG. 6.

In addition, the processor 130 of FIG. 2 may be implemented as one component, or may be separately implemented like the image control unit 131 and driving control unit 132 of FIG. 6.

The image control unit 131 may receive the image data from the outside, and determine the driving frequency for processing the image data. To this end, the image control unit 131 may determine the type of the image data through the above-described automatic content recognition function or determine the frame rate or frames per second of the image data based on the meta information of the image data.

In addition, the image control unit 131 may determine the driving frequency of the display apparatus 100 based on the type of the image data, the frame rate or frames per second of the image data, and control the driving control unit 132 to process the image data at the corresponding driving frequency.

The image control unit 131 may determine the driving frequency of the display apparatus 100 based on the mode of the display apparatus 100 that is selected by the user command, and control the driving control unit 132 to process the image data at the corresponding driving frequency.

The driving control unit 132 may process the image data at the basic driving frequency or the high-speed driving frequency under control of the image control unit 131. Here, the basic driving frequency may be the first driving frequency described above, and the high-speed driving frequency may be the second driving frequency described above.

For example, an image processing unit of the driving control unit 132 may convert the image data into the image data corresponding to the first driving frequency when receiving the control signal for processing the image data at the first driving frequency and the image data from the image control unit 131. In addition, a signal generation unit of the driving control unit 132 may generate the image signal corresponding to the plurality of pixels of the horizontal line based on the image data corresponding to the first driving frequency, and transmit the same to a source integrated circuit (IC) of the display panel 110 (here, the source IC may be the data driving unit described above).

In addition, a gate timing control unit of the driving control unit 132 may transmit a signal for outputting the gate signals by every one gate line to a gate unit of the display panel 110 (here, the gate unit may be the above-mentioned gate driving unit) to process the image data at the first driving frequency.

When receiving the control signal for processing the image data at the second driving frequency and the image data from the image control unit 131, the image processing unit of the driving control unit 132 may convert the image data into the image data corresponding to the second driving frequency. In addition, the signal generation unit of the driving control unit 132 may generate the image signal corresponding to the plurality of pixels of the horizontal line based on the image data corresponding to the second driving frequency, and transmit the same to the source IC of the display panel 110.

In addition, the gate timing control unit of the driving control unit 132 may transmit a signal for outputting the gate signals by at least every two gate lines to the gate unit of the display panel 110 to process the image data at the second driving frequency.

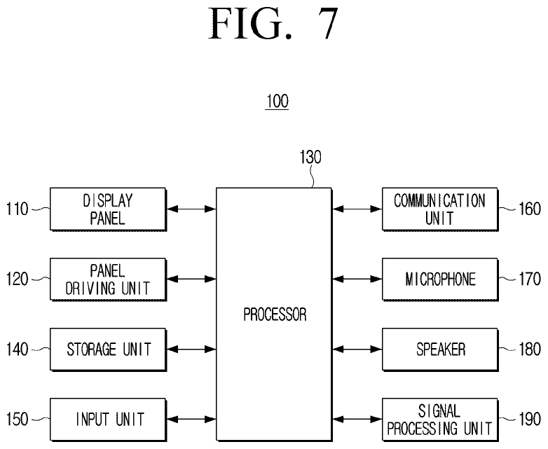

FIG. 7 is a block diagram illustrating an example configuration of the display apparatus according to various embodiments.

Referring to FIG. 7, the display apparatus 100 according to an embodiment of the present disclosure may include the display panel 110, the panel driving unit (e.g., including driving circuitry) 120, a storage unit (e.g., a memory) 140, an input unit (e.g., including input circuitry) 150, a communication unit (e.g., including communication circuitry) 160, a microphone 170, a speaker 180, a signal processing unit (e.g., including signal processing circuitry) 190, and the processor (e.g., including processing circuitry) 130. Hereinafter, parts overlapping the above description may not be repeated.

The storage unit 140 may include, for example, a memory and store an operating system (OS) for controlling overall operations of components of the display apparatus 100, and instructions or data related to the components of the display apparatus 100.

Accordingly, the processor 130 may include various processing circuitry and control the plurality of hardware or software components of the display apparatus 100 using various instructions or data stored in the storage unit 140, load and process instructions or data received from at least one of other components into a volatile memory, and store various data in a non-volatile memory.

The input unit 150 may include various input circuitry and receive various user commands. The processor 130 may execute various functions based on the user command input through the input unit 150.

For example, the input unit 150 may receive the user command for setting the mode of the display apparatus 100. In addition, the input unit 150 may receive the user command for performing turn-on, channel change, volume control, or the like, and the processor 130 may perform the turn-on, channel change, volume control, or the like of the display apparatus 100 based on the input user command.

To this end, the input unit 150 may be implemented as an input panel. The input panel may be implemented as a touch pad, or a keypad or a touch screen that includes various function keys, number keys, special keys, character keys, and the like.

The communication unit 160 may include various communication circuitry and communicate with the external device to transmit/receive various data. For example, the communication unit 160 may not only communicate with an electronic device through a local area network (LAN), an internet network, or a mobile communication network, but also communicate with the electronic device through various communication methods such as Bluetooth (BT), Bluetooth low energy (BLE), wireless fidelity (WI-FI), Zigbee, and near field communication (NFC).

To this end, the communication unit 160 may include various communication modules for performing network communication. For example, the communication unit 160 may include a Bluetooth chip, a Wi-Fi chip, a wireless communication chip, or the like.

For example, the communication unit 160 may receive the image data from the external device by communicating with the external device. Here, the external device may be a server, a smartphone, a computer, a laptop computer, or the like, and is not necessarily limited thereto.

The microphone 170 may receive a user voice. Here, the user voice may be a voice for executing a specific function of the display apparatus 100. When receiving the user voice through the microphone 170, the processor 130 may analyze the user voice using a speech to text (STT) algorithm and perform a function corresponding to the user voice.

For example, when receiving the user voice for setting the mode of the display apparatus 100 through the microphone 170, the processor 130 may operate in the first mode based on the user voice and process the image data at the first driving frequency, or operate in the second mode to process the image data at the second driving frequency.

The speaker 180 may output various sounds. For example, the speaker 180 may output sound corresponding to the image data.

The signal processing unit 190 may include various signal processing circuitry and perform signal processing on the image data received through the communication unit 160. In detail, the signal processing unit 190 may perform operations such as decoding, scaling, and frame rate conversion of an image included in the image data, and signal process the image data to have a form in which the image data may be output from the display apparatus 100. In addition, the signal processing unit 190 may perform the signal processing such as the decoding on an audio signal to signal process the audio signal into a form in which the audio signal may be output from the speaker 180.

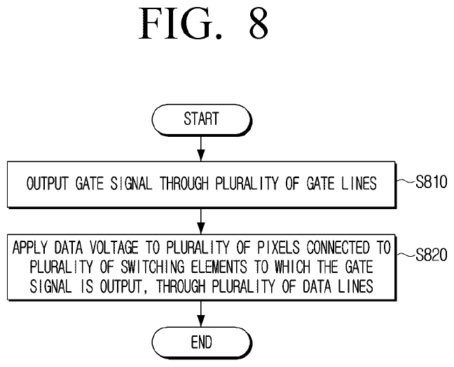

FIG. 8 is a flowchart illustrating an example method of controlling a display apparatus according to various embodiments.

A display apparatus 100 may output a gate signal through a plurality of gate lines (S810).

For example, the display apparatus 100 may sequentially output the gate signals by every one gate line to the plurality of gate lines to process image data at a first driving frequency in a first mode, and sequentially output the gate signals by at least every two gate lines to the plurality of gate lines to process the image data at a second driving frequency in a second mode.

The display apparatus 100 may then apply a data voltage to a plurality of pixels connected to a plurality of switching elements from which the gate signal is output, through a plurality of data lines (S820).

For example, the display apparatus 100 may apply the data voltage to the plurality of pixels based on timing at which the gate signals are sequentially output by every one gate line to the plurality of switching elements while operating in the first mode, and apply the data voltage to the plurality of pixels based on timing at which the gate signals are sequentially output by at least every two gate lines to the plurality of switching elements while operating in the second mode.

The mode of the display apparatus 100 may be determined based on a user command received through an input unit, as well as based on a type of image data, frames per second of the image data, or frame rate of the image data.

In addition, in various examples, the display apparatus 100 may convert the frames per second of the image data and process the image data at a high-speed driving frequency.

Methods according to the various example embodiments of the present disclosure described above may be implemented in the form of software or applications which may be installed in a conventional display apparatus.

In addition, the methods according to the various example embodiments of the present disclosure described above may be implemented only by software upgrade or hardware upgrade of the conventional display apparatus.

In addition, the various example embodiments of the present disclosure described above may be performed through an embedded server positioned in the display apparatus, or a server positioned outside the display apparatus.

Meanwhile, provided is a non-transitory computer-readable medium that stores a program sequentially performing the control method of a display apparatus according to the present disclosure.

The non-transitory computer readable medium is a medium that semi-permanently stores data and is readable by an apparatus. For example, the various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

In addition, although the embodiments are shown and described in the present disclosure as above, the present disclosure is not limited to the above mentioned specific embodiments, and may be variously modified by those skilled in the art to which the present disclosure pertains without departing from the gist of the present disclosure, including as claimed in the accompanying claims. These modifications should also be understood to fall within the scope and spirit of the present disclosure. It will also be understood that any of the embodiment(s) described herein may be used in conjunction with any other embodiment(s) described herein.

What is claimed is:

1. A display apparatus comprising:
a panel driving unit comprising driving circuitry;
a display panel including a plurality of pixels connected to a plurality of gate lines and a plurality of data lines through a plurality of switching elements, each switching element comprising switch circuitry; and
a processor configured to control the panel driving unit to output a gate signal through the plurality of gate lines, and to control the panel driving unit to apply a data voltage to the plurality of pixels connected to the plurality of switching elements to which the gate signal is output, through the plurality of data lines,
wherein the processor is configured to: control the panel driving unit to sequentially output the gate signals by every one gate line to the plurality of gate lines in a first mode to process image data at a first driving frequency, and
control the panel driving unit to sequentially output the gate signals by at least every two gate lines to the plurality of gate lines in a second mode to process the image data at a second driving frequency higher than the first driving frequency.

2. The apparatus of claim 1, wherein while operating in the first mode, the processor is configured to control the panel driving unit to apply the data voltage to the plurality of pixels based on a timing at which the gate signals are sequentially output by every one gate line to the plurality of switching elements, and
while operating in the second mode, the processor is configured to control the panel driving unit to apply the data voltage to the plurality of pixels based on a timing at which the gate signals are sequentially output by at least every two gate lines to the plurality of switching elements.

3. The apparatus of claim 1, wherein the gate line includes a first gate line and a second gate line, and
while operating in the first mode, the processor is configured to control a gate driving unit to output a first gate signal to the plurality of switching elements connected to the first gate line through the first gate line at a first timing, and to control the panel driving unit to output a second gate signal to the plurality of switching elements connected to the second gate line through the second gate line at a second timing.

4. The apparatus of claim 3, wherein while operating in the second mode, the processor is configured to control the panel driving unit to output the gate signal to the plurality of switching elements connected to the first gate line and the plurality of switching elements connected to the second gate line through the first and second gate lines at a same timing.

5. The apparatus of claim 1, further comprising an input unit comprising input circuitry,
wherein the processor is configured to operate in the first mode to process the image data at the first driving frequency based on receiving a command for setting a mode of the display apparatus to the first mode through the input unit, and
to operate in the second mode to process the image data at the second driving frequency based on receiving a command for setting the mode of the display apparatus to the second mode through the input unit.

6. The apparatus of claim 1, wherein the processor is configured to perform an automatic content recognition (ACR) function to determine a type of the image data based on receiving the image data from the outside,
to operate in the first mode to process the image data at the first driving frequency based on determining the type of the image data as a first type, and
to operate in the second mode to process the image data at the second driving frequency based on determining the type of the image data as a second type.

7. The apparatus of claim 1, wherein the processor is configured to determine frames per second (fps) of the image data based on receiving the image data from the outside,
to operate in the first mode to process the image data at the first driving frequency based on the frames per second of the image data having a first value, and to operate in the second mode to process the image data at the second driving frequency based on the frames per second of the image data having a second value.

8. The apparatus of claim 1, wherein the processor is configured to convert the image data into second image data having the frames per second of the second value based on receiving first image data having the frames per second of the first value from the outside, and to process the second image data at the second driving frequency.

9. A method of controlling a display apparatus, the method comprising:
outputting a gate signal through a plurality of gate lines; and
applying a data voltage to a plurality of pixels connected to a plurality of switching elements to which the gate signal is output, through a plurality of data lines,
wherein the outputting the gate signal comprises:
in a first mode, sequentially outputting the gate signals by every one gate line to the plurality of gate lines to process image data at a first driving frequency, and
in a second mode, sequentially outputting the gate signals by at least every two gate lines to the plurality of gate lines to process the image data at a second driving frequency higher than the first driving frequency.

10. The method of claim 9, wherein the applying the data voltage comprises:
while operating in the first mode, applying the data voltage to the plurality of pixels based on a timing at which the gate signals are sequentially output by every one gate line to the plurality of switching elements, and
while operating in the second mode, applying the data voltage to the plurality of pixels based on a timing at which the gate signals are sequentially output by at least every two gate lines to the plurality of switching elements.

11. The method of claim 9, wherein the gate line includes a first gate line and a second gate line, and
the outputting the gate signal comprises:
while operating in the first mode, outputting a first gate signal to the plurality of switching elements connected to the first gate line through the first gate line at a first timing, and outputting a second gate signal to the plurality of switching elements connected to the second gate line through the second gate line at a second timing.

12. The method of claim 11, wherein the outputting the gate signal comprises:
while operating in the second mode, outputting the gate signal to the plurality of switching elements connected to the first gate line and the plurality of switching elements connected to the second gate line through the first and second gate lines at a same timing.

13. The method of claim 9, further comprising:
receiving a command for setting a mode of the display apparatus; and
operating in the first mode to process the image data at the first driving frequency based on a command for setting the mode of the display apparatus to the first mode being received, and operating in the second mode to process the image data at the second driving frequency based on a command for setting the mode of the display apparatus to the second mode being received.

14. The method of claim 9, further comprising:
performing an automatic content recognition (ACR) function to determine a type of the image data based on the image data being received from the outside; and
operating in the first mode to process the image data at the first driving frequency based on the type of the image data being determined as a first type, and operating in the second mode to process the image data at the second driving frequency based on the type of the image data being determined as a second type.

15. The method of claim 9, further comprising:
determining frames per second (fps) of the image data based on the image data being received from the outside; and
operating in the first mode to process the image data at the first driving frequency based on the frames per second of the image data having a first value, and operating in the second mode to process the image data at the second driving frequency based on the frames per second of the image data having a second value.
